(19) United States
(12) Patent Application Publication
(10) Pub. No.: US 2006/0224979 A1
(43) Pub. Date: Oct. 5, 2006

(54) Apparatus for creating graphical application interface

(76) Inventors: Paul Albrecht, Bedford, MA (US); Kimberly Chiu, Quincy, MA (US); Paul Grimshaw, Acton, MA (US); Joseph G. Hadzima JR., Wellesley, MA (US); Hoo-Min D. Toong, Cambridge, MA (US)

Correspondence Address: BERKELEY LAW & TECHNOLOGY GROUP, 1700NW 167TH PLACE, SUITE 240, BEAVERTON, OR, 97006, US

(21) Appl. No.: 11/096,931

(22) Filed: Apr. 1, 2005

(51) Int. Cl. G06F 17/00

(52) U.S. Cl. 715/760

(57) ABSTRACT

Embodiments of an apparatus for creating a graphical application interface are disclosed.

### RELATED APPLICATIONS

The following concurrently filed patent applications are commonly assigned, related to this patent application, and herein incorporated by reference: “GRAPHICAL APPLICATION INTERFACE,” by Albrecht et al., attorney docket number 023.P005, U.S. patent application Ser. No. ______; “SYSTEM FOR CREATING A GRAPHICAL APPLICATION INTERFACE,” by Albrecht et al., attorney docket number 023.P006, U.S. patent application Ser. No. ______; “GRAPHICAL APPLICATION INTERFACE PRODUCT,” by Albrecht et al., attorney docket number 023.P007, U.S. patent application Ser. No. ______; “METHOD OF USING A BROWSER,” by Albrecht et al., attorney docket 023.P001, U.S. patent application Ser. No. ______; “METHOD OF CREATING GRAPHICAL VISUALIZATIONS OF DATA WITH A BROWSER,” by Albrecht et al., attorney docket 023.P003, U.S. patent application Ser. No. ______; “APPARATUS FOR CREATING GRAPHICAL APPLICATION INTERFACE WITH A BROWSER,” by Albrecht at al., attorney docket number 023.P008, U.S. patent application Ser. No. ______; “GRAPHICAL APPLICATION INTERFACE USING BROWSER,” by Albrecht et al., attorney docket number 023.P009, U.S. patent application Ser. No. ______; “SYSTEM FOR CREATING A GRAPHICAL APPLICATION INTERFACE WITH A BROWSER,” by Albrecht et al., attorney docket number 023.P010, U.S. patent application Ser. No. ______; “GRAPHICAL APPLICATION INTERFACE PRODUCT USING A BROWSER,” by Albrecht et al., attorney docket number 023.P011, U.S. patent application Ser. No. ______; APPARATUS FOR CREATING GRAPHICAL VISUALIZATION OF DATA WITH A BROWSER,” by Albrecht at al., attorney docket number 023.P012, U.S. patent application Ser. No. ______; “GRAPHICAL VISUALIZATION OF DATA USING BROWSER,” by Albrecht et al., attorney docket number 023.P013, U.S. patent application Ser. No. ______; “SYSTEM FOR CREATING A GRAPHICAL VISUALIZATION OF DATA WITH A BROWSER,” by Albrecht et al., attorney docket number 023.P014, U.S. patent application Ser. No. ______; and “GRAPHICAL VISUALIZATION OF DATA PRODUCT USING A BROWSER,” by Albrecht et al., attorney docket number 023.P015, U.S. patent application Ser. No. ______.

### BACKGROUND

Software for browsing, such as for browsing stored data and/or for web-browsing, is well-known. Although at times convenient, this approach to presenting data has some disadvantages. For example, it may be difficult to provide end-users with features of an interface typically associated with a software application, such as, for example, context sensitive pop-up menus and/or other graphical features, referred to here as graphical application-like interface features. A reason for this at least in part is the use of HTML to layout text, images and/or other data on a page, such as a web page. HTML is not convenient to use in providing such features.

One approach to address this issue is the use of browser or web-browser “plug-ins.” Here, this refers to software that operates in conjunction with web-browser software to provide a desired graphical application-like interface. However, employing such software raises other issues, such as security concerns and/or work-flow issues in connection with use of the browser, for example.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram illustrating an embodiment of a browser window;

FIG. 2A is a schematic diagram illustrating the embodiment of FIG. 1 in greater detail;

FIG. 2B is a screen shot of a particular embodiment of a landscape map viewed via a browser window;

FIG. 3 is pseudo-code for an embodiment of a browser window with graphical application-like features;

FIG. 4 is an alternate embodiment to FIG. 3;

FIG. 5 is another alternate embodiment to FIG. 3;

FIG. 6 is yet another alternate embodiment to FIG. 3;

FIG. 7A is pseudo-code for an embodiment of a browser window with graphical application-like features;

FIG. 7B is a flowchart for an embodiment of a browser window with graphical application-like features;

FIG. 8A is pseudo-code and a schematic diagram for an embodiment of a browser window with graphical application-like features;

FIG. 8B is a flowchart for an embodiment of a browser window with graphical application-like features;

FIG. 9A is pseudo-code for an embodiment of a browser window with graphical application-like features;

FIG. 9B is pseudo-code for an embodiment of a browser window with graphical application-like features;

FIGS. 10 and 11 illustrate pseudo-code for an embodiment of a browser window with graphical application-like features;

FIG. 12 is a schematic diagram for an embodiment of a browser window with graphical application-like features;

FIG. 13 is a flowchart for an embodiment of a browser window with graphical application-like features;

FIGS. 14, 15A, and 15B illustrate pseudo-code to produce an embodiment of a browser window with graphical application-like features;

FIG. 16 is pseudo-code for an embodiment of a browser window with graphical application-like features;

FIGS. 17A-D are flowcharts for an embodiment of a browser window with graphical application-like features;

FIGS. 18A and B illustrate pseudo-code for an embodiment of a browser window with graphical application-like features;

FIG. 19A is pseudo-code for an embodiment of a browser window with graphical application-like features;

FIGS. 19B-C are flowcharts for an embodiment of a browser window with graphical application-like features;

FIGS. 20A-C are flowcharts for an embodiment of a browser window with graphical application-like features;

FIGS. 21 and 22 illustrate pseudo-code to produce an embodiment of a browser window with graphical application-like features; and

FIG. 23 is a flowchart for an embodiment of a browser window with graphical application-like features.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

As previously alluded to, Hypertext Markup Language (HTML) has become a universal language that has enabled rapid growth and standardization of the Web. However, unfortunately, the language is not designed for creating graphical application-like features. HTML derives from a document markup language, Standard Generalized Markup Language (SGML), which is not a user-interface design language. HTML is, therefore, focused on the layout of text input and text output elements and the layout of images, but not on creating graphical operations including intricate operations. Hence, the interactive functionality that is possible in a graphical application executing on a state-of-the art computing platform, for example, has not been seen using HTML-based pages, such as web pages.

A common workaround for this issue has been the creation of plug-ins for browsers. The plug-ins work with the browser through a prescribed plug-in application programming interface (API). The browser typically employs a set screen area to allocate for the plug-in, but is not typically involved in determining the contents of the screen area. An example of a common plug-in used to deliver graphical content or game applications includes Flash or Shockwave software, available, for example, from Marcomedia. Commonly, plug-ins for Internet Explorer are designed using ActiveX controls. Java counterparts to ActiveX controls are referred to as applets. Applets are generally supported by common browsers, such as Netscape and Internet Explorer. An issue with ActiveX controls and Java Applets is that they are downloaded to the particular computing platform before being used to render graphical content. This may have security implications and/or workflow implications, for example.

For Internet Explorer, for example, the ActiveX controls may access many elements of the particular computing platform and may make modifications, capture and/or transmit information back to a service via the Internet—sometimes without the platform user's knowledge. Thus, it is not unusual for ActiveX controls from some web sites to load spyware and/or ad-ware onto a user's computing platform. Thus, the particular computing platform user may be taking some risk if a plug-in is downloaded.

Likewise, the use of plug-ins may make workflow more cumbersome for a user. Downloading a plug-in for a particular application may take many minutes. For example, for applications that are being routinely updated, this may involve downloads if an application is used or changed.

In contrast, HTML does not have the security and workflow issues associated with plug-ins. However, the absence of a convenient method for creating graphical application-like features in HTML has impeded its use in certain computing environments. Further complicating the task is that different browser software may not interpret HTML pages the same way. What follows is a description of particular embodiments of a method and/or system of using a browser, such as a web-browser, to create graphical application-like features, in this particular embodiment, an HTML-based application, for example. It is appreciated that claimed subject matter is not limited in scope to the embodiments described such as HTMP, for example. These embodiments are merely provided as examples of possible implementations within the scope of claimed subject matter. It is specifically intended that subject matter claimed be broader and more encompassing than simply the particular embodiment, described. It is also noted that any subject headings and/or other transitions in the material that follows are merely provided for the convenience of the reader and are not intended to limit the scope of claimed subject matter in any way.

In this context, the term HTML document refers to any content in any form, such as an electronic form, that is provided in a format that is HTML compatible or readable. HTML elements used in the <body> of an HTML document are classified for this particular embodiment as either block-level elements or inline elements. Inline elements typically may include text and other inline elements. If rendered visually, inline elements do not usually begin on a new line. Block-level elements typically include inline elements and other block-level elements. Block-level elements usually begin on a new line.

Although claimed subject matter is not limited in scope in this respect, some of the embodiments described here use an HTML grouping element, <div>, for nesting other HTML components or elements. The grouping element <div> comprises a versatile block-level element of HTML, although it is noted that alternate HTML operators, such as other grouping elements, may also be employed in alternate embodiments. Likewise, embodiments may also employ other code other than HTML-based code.

In this particular embodiment, a raster style coordinate system is employed. For this embodiment, the origin (e.g., the top, left) of an element is defined to be (x,y)=(0,0). The value of x increases from left to right; however, the value of y increases from top to bottom. It is, of course, appreciated that many other approaches may be employed and are included within the scope of claimed subject matter.

For this particular embodiment, the nesting of HTML elements forms a parent-child relationship. Here, the child elements may be placed inside the parent element at any desired location using the “top” and/or “left” properties of the child. The (left, top) coordinate specifies the location of the child's origin in terms of the (x,y) coordinate, respectively, of the parent. For positioning, it may be desirable that the value of the “position” attribute be “absolute,” although in alternate embodiments relative positioning may also be employed. Positioning may also or alternatively be accomplished by using the “right” and/or “bottom” attributes. If both (left, top) and (right, bottom) are specified, it may be desirable in some situations to omit “width” and/or “height” attributes, although this may depend at least in part on the particular embodiment and/or the particular situation.

In one particular embodiment, dynamic HTML (DHTML) may also or alternatively be employed to enable graphical application-like features without the need for a browser plug-in, although, again, claimed subject matter is not limited in scope to employing DHTML or HTML. In this embodiment, for example, DHTML offers an alternative to employing HTML, which is generally static for a page, such as a web page, or for frames within a page or web page, such as a page that may be loaded and/or stored on a server, for example. With DHTML, a scripting language, such as JavaScript, for example, available from Sun Microsystems, for example, executing within a browser, for example, may be used to dynamically create and/or control one or more HTML objects on a page or a portion of a page. This may be done in one embodiment, for example, by using JavaScript, to load the inner HTML of HTML objects, such as <div> objects, for example, and/or to create and/or manipulate HTML objects through the Document Object Model (DOM) interface. It is noted, of course, that this is merely one embodiment and claimed subject matter is not limited in scope in this respect.

For example, for this embodiment, after an HTML page is initially loaded into a browser, additional data may be dynamically obtained from a server using JavaScript. One way to do this may include using <IFrame> objects to request additional data from the server. An alternative may include using XML Http Request technology, which is supported by more recent browser versions, such as Internet Explorer Browser 6.0 and/or Mozilla-based Netscape 7.0 browser. For example, both of these browsers support JavaScript and Document Object Model (DOM). Thus, it may be possible, for at least some embodiments to provide JavaScript code using a common subset that works in multiple browsers. A difference between the browsers, however, may include the way that events are handled, for example JavaScript (JS) code typically detects the browser type to implement event handling. Another difference may include syntax for invoking an XML Http Request. Thus, in some embodiments, different code may be employed depending at least in part on the particular browser.

As previously suggested, for this particular embodiment, the use of Dynamic HTML (DHTML) and JavaScript may make it possible for a page, such as a web page, to behave more like a graphical application. In this context, features that make an interface behave like a graphical application are referred to as graphical application-like features. For this particular embodiment, use is made of JavaScript objects. Thus, for this particular embodiment, JavaScript user interface (UI) objects have member variables representing the state of UI objects. Such objects in this particular embodiment are also employed to create HTML and to implement the functionality of such UI objects. Of course, claimed subject matter is not limited in scope to employing JavaScript objects or UI objects. Nonetheless, here, for this particular embodiment, for the purpose of discussing HTML objects, such as <div>, as one example, it shall be understood that this may refer to actual HTML text or it may refer to one or more corresponding Document Object Model (DOM) elements and/or one or more elements created by a browser from HTML.

It is noted that in the particular embodiment description that follows, examples that are discussed include patent related data such as patent maps, patent lists, patent application data and/or analysis and the like; however, claimed subject matter is not limited in scope in this respect. More specifically, claimed subject matter is intended to encompass a wide range of potential applications and/or data, of which patent related data is merely one example. Thus, claimed subject matter is intended to cover any and all potential applications, such as web applications, for example.

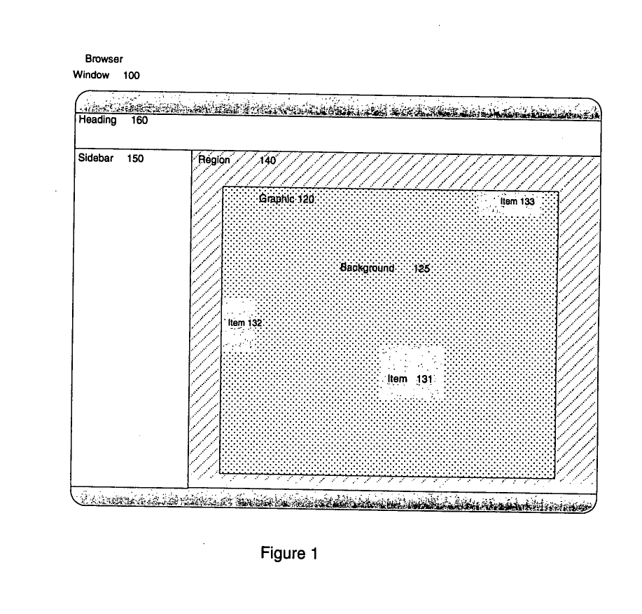

FIG. 1 is a schematic diagram illustrating an embodiment 100. This particular embodiment shows a browser window for a web application that shows a graphic 120 within a region 140. Here, graphic 120 shows items 131-133, which may represent issued patents, although, as previously mentioned, claimed subject matter is not limited in scope in this respect. These items may comprise any object and/or data that it may be convenient to illustrate graphically. However, continuing with this example for this particular embodiment, items 132-133 appear to be clipped. Thus, here, the entire object is not illustrated on graphic 120 via the browser. Graphic 120 in this particular embodiment also has background 125 which may contain graphics that form the background for these items. It is noted that this particular embodiment also includes heading 160 and sidebar 150, although, again, claimed subject matter is not limited in scope in this respect.

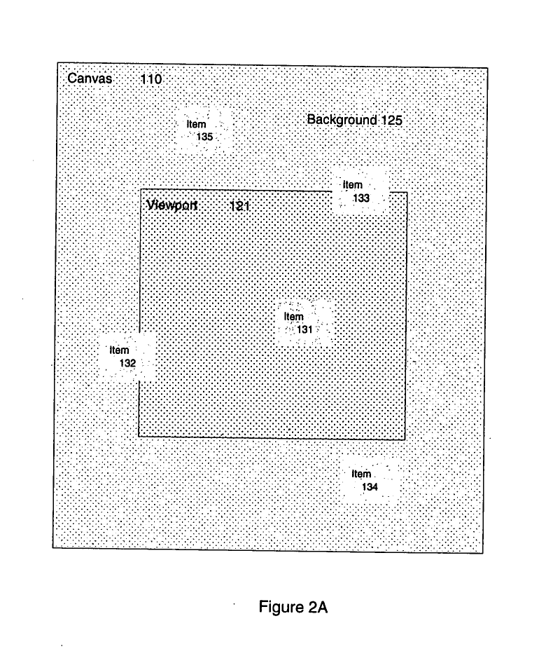

FIG. 2A illustrates the embodiment of FIG. 1 with more detail. FIG. 2A illustrates that graphic 120 includes canvas 110 and canvas 110 comprises background 125 and items 131-135, in this particular embodiment, map items, although claimed subject matter is not limited in scope in this respect. Here, canvas 110 is viewed through a viewport 121, which here shows the part or portion of canvas 110 that coincides with the viewport. Other parts or portions of the canvas are, therefore, not visible in this particular embodiment.

Here, graphic 120 of FIG. 1 corresponds to viewport 121 of FIG. 2A and items 131-133 of FIG. 1 correspond to items 131-133 of FIG. 2A. Without loss of generality, FIG. 2B shows a screen shot of a particular graphic that includes a map, in this example, a patent landscape map. Here, a patent landscape map refers to a map of patents where interconnecting illustrate citation relationships. It is again noted that this is simply an example and does not limit the scope of claimed subject matter in any way. Likewise, FIG. 2B includes, in this particular example, as illustrated, viewport overview 180, canvas overview 181, item 182, canvas background 183, canvas edge 184, viewport background 185 and viewport edge 186.

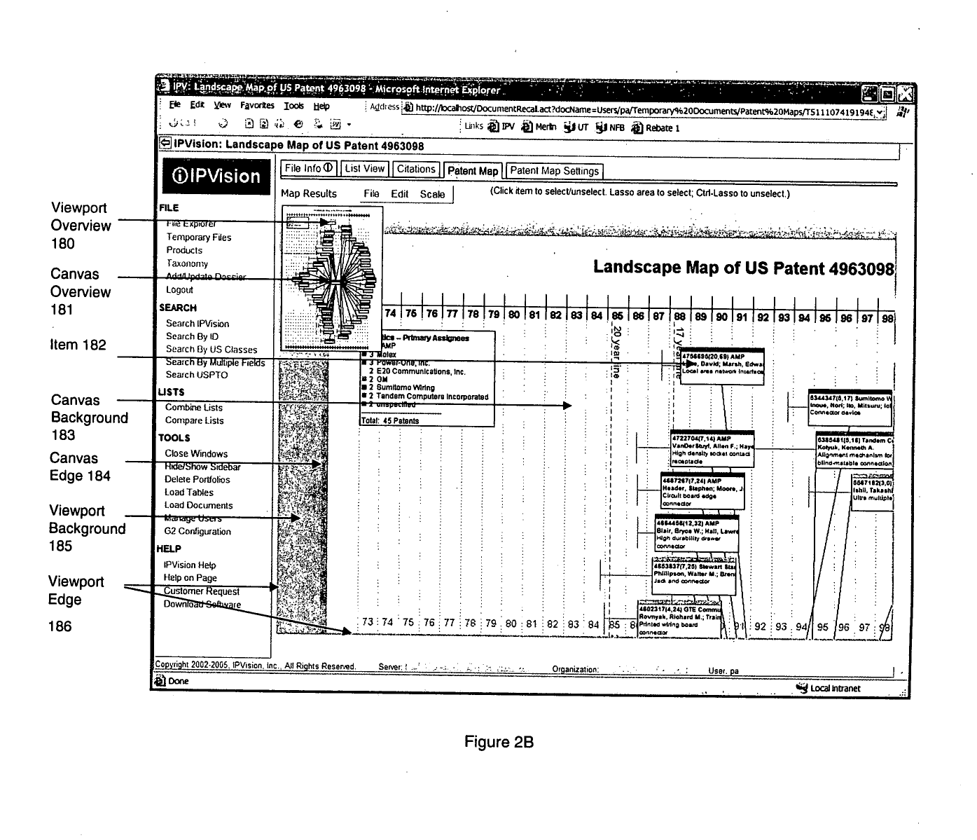

An outline of one technique for employing HTML to produce FIG. 2A, for example, is shown in FIG. 3. Again, this is merely an example and does not limit the scope of claimed subject matter. In this particular example, viewport 121, canvas 110, background 125 and items 131-135 are represented by a <div>. Viewport <div> includes canvas <div>. Likewise, in FIG. 3, the viewport here has an “overflow” property of “hidden,” which instructs a browser to hide or clip child elements of the viewport that lie outside its boundaries. The boundaries of the viewport in this example extend from (0, 0) to (500,500).

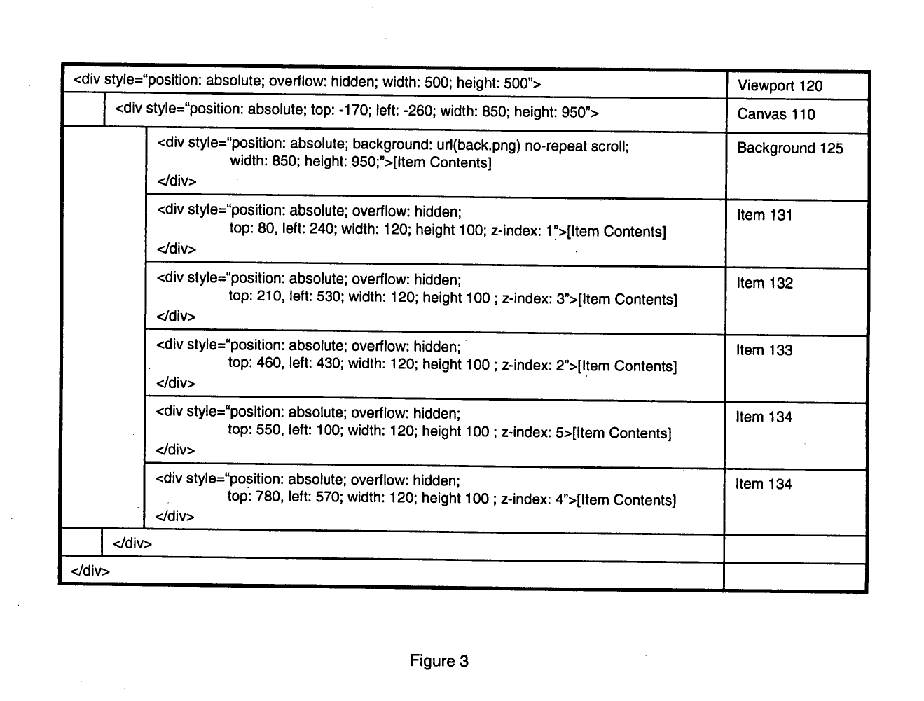

For this embodiment, the part or portion of the canvas that is visible through the viewport is determined at least in part by the position of the canvas within the viewport. In this particular example, this is specified by “top” and/or “left” properties of the canvas. In FIG. 3, “top” and “left” comprise −170 and −260, respectively, indicating that a (top, left) corner of the canvas is located 170 pixels to the left, and 260 pixels above the (top,left) corner of the viewport. Of course, there are many potential variations and claimed subject matter is intended to cover all of the possibilities. For example, in FIG. 3, <div> 130 may be omitted, and “background: url(back.png) no-repeat scroll;” may be included, instead, in the style attribute of canvas 110 as shown, for example, in FIG. 4. Note that portions of FIG. 4 are highlighted here for emphasis of illustration only.

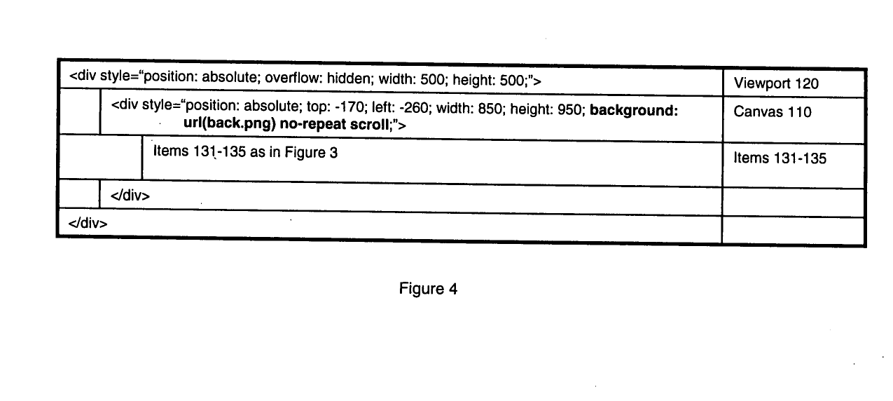

FIG. 5 illustrates yet another variation included within the scope of claimed subject matter. This example uses <img> 136, instead of <div>, for the background portion of the graphic. One issue of using <img> that is discussed below for the background relates to an “onselectstart” event handler for <img>. In particular, for this embodiment, disabling certain selection capabilities may be desirable so that interactive capability may be provided, as discussed in more detail below.

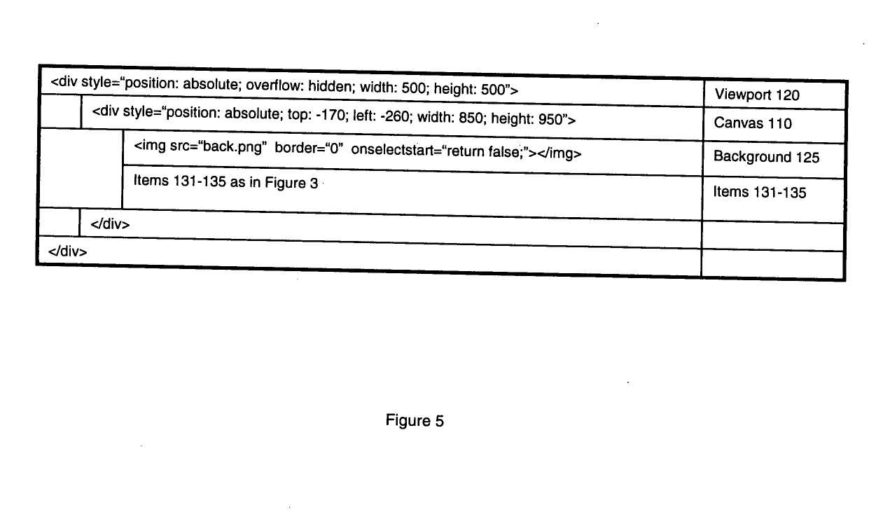

FIG. 6 illustrates still another variation. This example uses <map> for the canvas containing the image or graphic. The <map> background image may be specified by <img>, which here is linked by the “usemap” attribute that associates it with the “name” attribute of <map>. Here, <map> includes <area> elements 171-175 that specify active regions of a bitmap image. Here, “href” defines Javascript code that may be executed by a browser to send commands to a “jItem” object, if an area is selected, such as by a mouse click, for example.

One advantage of this latter particular variation is that the item elements and their contents (e.g., FIG. 3, items 131-135) may be assembled “on-the-fly” or in real-time, if they are employed to display additional information that is not on <map>. This is useful in situations, for example, that may include a relatively large number of items which might be potentially time consuming for a browser to construct and render, for example. In one embodiment, a page may also construct the items and show or hide items using “onfocus” and/or “onblur” event handlers that may be specified for <area> elements, although claimed subject matter is not limited in scope in this respect.

If there are many items on the canvas, it may be advantageous to create the items are the time they are going to be visible through the viewport. This may be achieved by assembling objects on-the-fly using JavaScript to access the Document Object Model (DOM) of the browser, for example. One implementation for on-the-fly creation of an item is as follows, although claimed subject matter is not limited in scope in this respec: The “jCanvas” object may include data to create the HTML for an item. The datamay include the location and size of the item as it will appear on the canvas, and whether the object has been rendered onto the canvas. The “jViewport” object may notify the “jCanvas” object as to what section of the canvas is visible. The “jCanvas” object may execute the data for the items and, for the ones that have not been rendered, it may check to see if the item overlaps the visible section of the viewport, or is within a few pixels of being visible, in the viewport. If so, the “jCanvas” object may build the HTML for the item, build the item element and add it to the canvas. If we assume, for example, that the 123^{rd} item on the canvas appears at location (top,left) of 100, 200 and is 120 pixels wide and 80 pixels high, HTML that may be used to create the item may be formed as:
var itemHTML=‘<div id=“item123”
   style=“top 100, left: 200; width: 120; height:
   80 . . . ”> . . . </div>’

where the “. . . ” indicates additional HTML that determines the additional visual details of the item. Assuming that the DOM element id for the canvas is “canvasID”, an item may added to the canvas using the following approach, although, again, claimed subject matter is not limited in scope in this respect:
var canvas=document.getElementById(“canvasID”);
var newItem=document.createElement(“DIV”);
canvas.appendChild(newItem);
newItem.innerHTML=itemHTML;

One technique to accommodate canvas 110 in viewport 120 is to set the “overflow” attribute of the canvas to “scroll.” This would typically produce scroll bars for the viewport to accommodate a larger canvas, if applicable. Depending at least in part on the particular situation, however, other approaches may be desirable to employ instead or in addition.

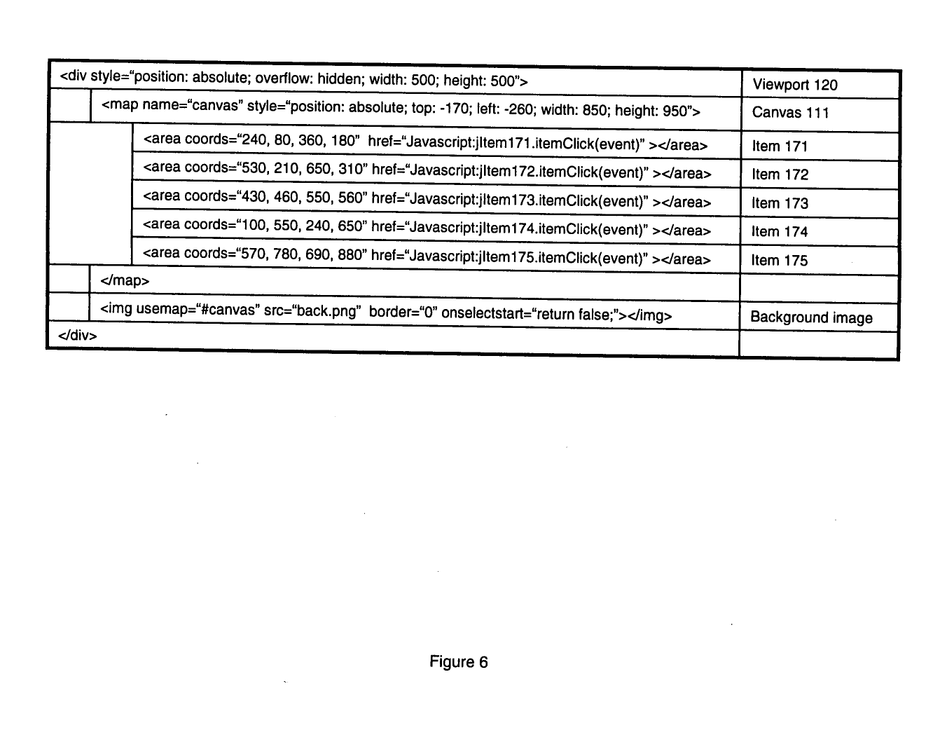

For example, one technique for moving the canvas around the viewport is to “grab” the canvas by an input device, such as a mouse button, for example, actuated, such as by a mouse click in this example. While the device is actuated, such as the mouse button remaining pressed, for example, the canvas may move substantially in accordance with the motion of the mouse. Referring to FIG. 3, for example, a “mousedown”, “mouseup” and “mousemove” eventhandler may be added to viewport <div> 120, as shown in FIG. 7A. Here, the events are sent to a Javascript object named “jViewport”, which handles the events and implements logic to move the canvas.

FIG. 7B is a flowchart illustrating an embodiment of a process implemented by a “jViewport” object in this example. Of course, claimed subject matter is not limited in scope to this embodiment. The “grab” begins with the “mousedown” event 200 which may initiate a “grab” mode. In this mode, mouse position may be recorded as (x0,y0) in 202. During this mode, “mouseup” and “mousemove” events are handled for the viewport. If a “mousemove” 204 occurs, the current position of the mouse (x1,y1) may be recorded, and the canvas (left,top) may be updated at 206 by adding (x1-x0, y1-y0). If an overview tool is employed, however, as discussed in more detail below, the updated (left, top) position of the canvas at 208 may be sent to the “jOverview” object, which may handle the overview tool. If a “mouseup” event occurs at 210, the “grab” mode ends at 212 and the mouse motion no longer affects movement of the canvas within the viewport in this particular embodiment.

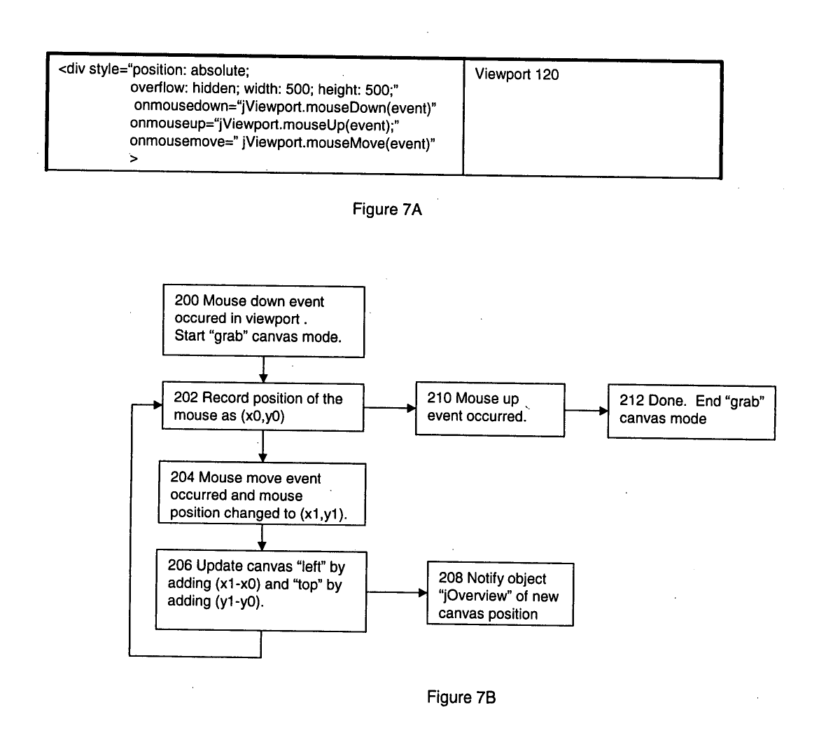

Yet another technique of moving the canvas is to use an overview tool, as illustrated in FIG. 8A and described in more detail below. Here, an overview tool comprises a canvas overview <div> 112, which provides a miniature representation of the canvas (e.g., canvas 110 in FIG. 2 in this example). Inside this representation is a viewport overview <div> 122, which comprises a semi-transparent rectangle that indicates the part or portion of the canvas that may be visible through the viewport. Again, signals from an input device, such as mouse events, for example, are sent to an object “jOverview”, which may implement an embodiment of a process, such as the one shown in FIG. 8B, for example.

Referring to FIG. 8B, a “mousedown” event in the canvas overview may start an overview mode. The coordinates of the mouse event may be recorded at 222. If a “mousemove” event occurs, the mouse position may be recorded at 224 and the viewport overview coordinates may be updated by adding (x3-x2,y3-y2) to the (left,top), resulting in movement inside the canvas overview in this embodiment. An “jOverview” object at 228 may compute a coordinate transformation from overview coordinates to canvas coordinates. Thus, computing the canvas (left,top) corresponds to the (left,top) of the viewport overview in the canvas overview <div>, in this particular embodiment. Here, the “jOverview” object may set a LOCKOUT_FLAG, call the “jViewport” object to instruct it to move the canvas to an updated (left,top) position, and unsets a LOCKOUT_FLAG. If a “mouseup” event occurs, indicated at 236, mode ends “grab” at 238, and the mouse motion no longer affects canvas movement within the viewport. Likewise, the “jOverview” and “jViewport” objects may also work cooperatively so that motion resulting from “grabbing” the canvas may be mirrored in motion of the viewport overview, in this embodiment. The “jViewport” object may notify the “jOverview” object at 232 if the canvas position changes. If the LOCKOUT_FLAG is set, which indicates that the change in canvas position was due to a change in the overview, the notification may be ignored. Otherwise, the “jOverview” object may compute a coordinate transformation of the canvas (top,left) to the corresponding point on the canvas overview, and may set the (top,left) of the viewport overview to the transformed (top,left) location or position.

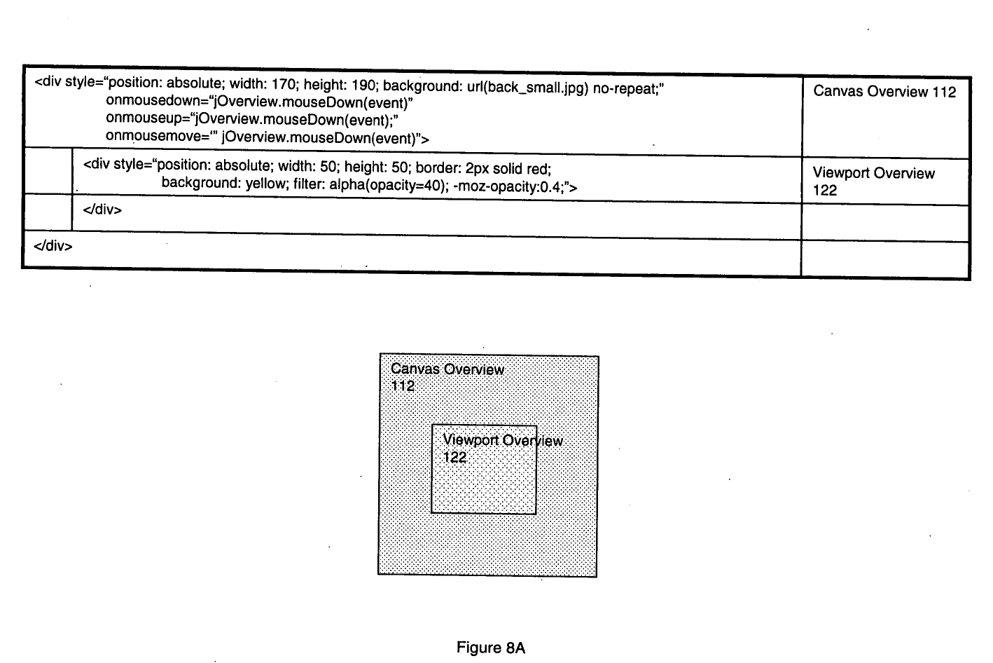

Another technique for graphically selecting a rectangular area in an application may include an input device click and drag to define a rectangular selection region. This may be accomplished by mouse events, for example. In this type of selection, the outline or translucent body of the rectangle may be shown and updated as the user moves the mouse. Unfortunately, there is no well-defined way of doing this in HTML; however, a similar effect may be achieved using the approach shown in FIGS. 9A-9B and described below. The logic may be handled by an object referred to here as “jMouseSelect.”

Thus, in one particular embodiment, a dynamically sized selection rectangle may be implemented for the viewport. If a “mousedown” event occurs in the viewport, the “jViewport” object which receives that event may call the “jMouseSelect” object. The “mousedown” event and a DOM element corresponding to the viewport may be passed as arguments to the “jMouseSelect” object. The “jMouseSelect” object may use <div> 302 show in FIG. 9A as a container for the selection rectangle. Note that <div> 302 is at the top level of the document. The high z-index of the selection container here is used so that its contents, if visible, will appear visible over other sibling HTML elements on the page. The “jMouseSelect” object may set the “innerHTML” of <div> 302 to include <div> 304 shown in FIG. 9B, and may set the <div> 304 (top,left) a (x0,y0) value of an initial “mousedown” event may be passed by a “jViewport” call. The “jMouseSelect” object may set the “display” property of <div> 302 to “block” so that a selection rectangle may be visible and override the event handling for the window/document so that it will intercept other mouse events. As suggested above, in this embodiment, “onselectstart” is also captured and cancelled here so that selecting images and text elements does not take place as an input device, such as the mouse is moved around with a button pressed. If a “mousemove” event is received by a “jMouseSelect” object, the object uses a (x1, y1) coordinate to compute an updated (left,top) and (right,bottom position) for the selection rectangle as follows:
var left=Math.min(x1, x0);
var top=Math.min(y1, y0);
var bottom=Math.max(y1, y0);
var right=Math.max(x1, x0);
   If a bounding DOM element has been specified as a second argument during initialization, as may be the case, for example, for this particular embodiment, the left, top, right and bottom varables may be adjusted to fit inside the bounding rectangle defined by the DOM element. This computation in this embodiment is performed as follows:
left=Math.max(left, selectionBounds.left);
top=Math.max(top, selectionBounds.top);
bottom=Math.min(bottom, selectionBounds.bottom);
right=Math.min(right, selectionBounds.right);
   where the “selectionBounds” object contains boundaries of the viewport DOM element. Position and size attributes of the <div> 302 DOM element are set as:
style.top=top;
style.left=left;
style.width=Math.max(right-left,1)+“px”;
style.height=Math.max(bottom-top,1)+“px”;
   thereby adjusting the visible rectangle on the screen for this embodiment. The viewport may be called with an updated selection rectangle, allowing the viewport to process items in the selection rectangle. The viewport may also change the visuals of its individual items to reflect that they have been selected or deselected. If an “jMouseSelect” object receives a “mouseup” event, a (x1, y1) coordinate of a mouseup event may be used to update a selection rectangle according to the procedure above, and click and drag mode may be ended. The window/document event capture may be restored to its previous state. The “display” attribute of <div> 302 may be set to “none”, thereby hiding the selection rectangle, and the viewport may be called to indicate the end of click and drag mode in this embodiment.

A variation may be to combine operations, such as <div> 302 and <div> 304, into an HTML element by combining style properties, and performing the rectangle positioning and sizing, as described above, on that element. Another variation may include capturing the mouse events in one of the DOM elements (e.g., the viewport) instead of at the window/document level. However, again, claimed subject matter is not limited in scope to any particular variation and also covers additional variations that may be implemented alternately or in addition to these approaches.

The “back” button of a browser may undesirably affect pages constructed from DHTML. Typically, fields that had been dynamically generated or changed by DHTML during processing may not appear or may not have the same value that was present at the time a page transition may have occurred. One technique to address this may include saving the page state and using that state if reloading the page. A page state may be stored in cookies, but this may present other problems if the amount of data is large or if multiple instances of a page are being used.

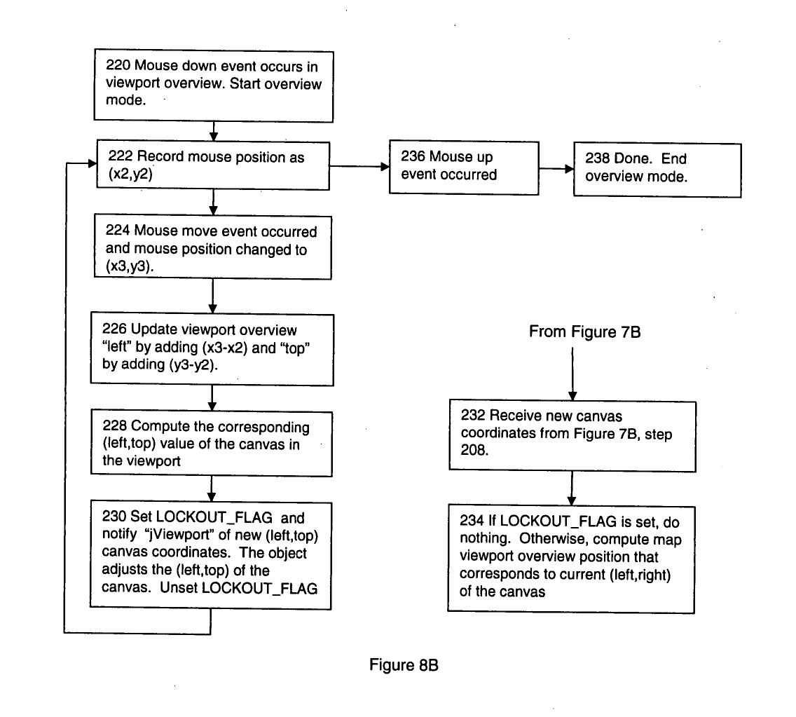

FIG. 10 shows an embodiment of a method for saving a page state, in this particular embodiment, saving a state within the page itself. A hidden <input> element 320 with the id=“pageState” may be is used to store a page state serialized into a string. Function 332 doSaveState( )may be called if the state of a page is changed, such as if new fields are shown or values of fields are updated. At 333, the function may clear a timer associated with loading the state. For example, the variable “value” defined at 334 may be set by JavaScript code that may collect page state information and serialize it into a string. The string containing the serialized page state may be stored in a hidden input field at 335. Function 336 doStateLoad( )may be called to configure the page from the saved state. The function extract the serialized page state into a variable “value” at 338, and execute code to de-serialize the state, extract variables and objects, and build to and/or initialize the appropriate DHTML to reflect the stored state. If a page is loaded or reloaded, such as by a “back” button being clicked on a browser, for example, a doStateLoadTimer( ) function may be called at 350. The doStateLoadTimer( ) function is defined at 342 for this embodiment. The function may check, in this embodiment, <input> including the page state to see if it has been rendered and if it is not null. If a page state string is available, a doStateLoad( ) function may be called at 346. Otherwise, another timer may be started at 348 to call the doStateLoadTimer( ) function 50 milliseconds later in this particular embodiment.

HTML windows may have a wide range of initial sizes. Furthermore, a window may be re-sized, such as by the user, once rendered. In one embodiment, graphical elements may be implemented so as to resize or autosize themselves to their containing DOM element, with the resize/autosize being handled like the initial rendering of a page. DHTML-based user interface graphics, such as an interactive graphic, such as a map, for example, may be created using JavaScript code. The code may build and size the HTML which may be used to set the “innerHTML” attribute of the workspace container or one of its sub-elements.

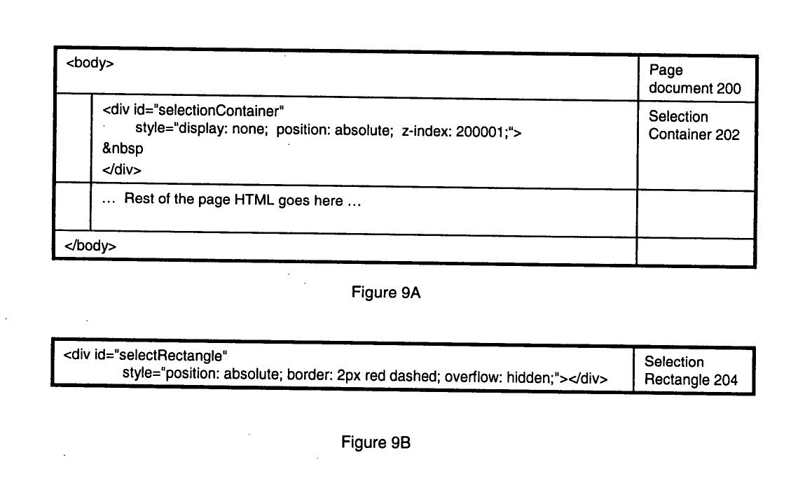

Referring to FIG. 11, a graphical element may be rendered on a page by setting the “innerHTML” of the <td> element whose id is “widgetId”. If the page is being loaded, the doWidgetResizeTimer( ) function may be called at 370. The body for the function is defined for this embodiment at 362. The function may set the “domElem” variable to the handle of the <td> DOM element at 364. In this embodiment, if “domElem” is defined and the size of the DOM element is not empty, the function may create a new UIWidget object, thereby giving it the dimensions of its enclosure, and setting the innerHTML of the <td> to the HTML produced by the UIWidget at 365. If “domElem” is null, the browser may not have yet figured out the size of the table and rendered it. In that case, or if the size is empty, the function may set up to call itself again 50 milliseconds later in this embodiment. In this embodiment, if at any time the window is resized, the “onresize” event handler for the <body> may call the doWidgetResizeTimer( ) to build a properly sized UIWidget.

A graphical overview of a large number of elements may be visualized if the elements are presented in a visual display of a browser, e.g., as in a patent map, for example. However, if there are a large number of elements, to fit the elements in the display, the size of a particular element in the display may be so small as to not be readable by an unaided human eye. It may be possible to “zoom” the graphic, however, zooming may remove the overview context. An overview typically is desirable to see patterns and to investigate large numbers of elements as a group or clusters, but it may be also desirable to, at times, see the details of particular elements without necessarily losing the overview context.

The goals of retaining an overview and also providing readability and accessibility may be achieved by using a flyover or hover window. For example, as a cursor is moved across an overview graphic, if it encounters a visual representation of one or a small number of particular elements, a magnified view of that or these elements including information about the element may be created dynamically using DHTML. This hover window or flyover may verify that the cursor is over one or more elements and it also may activate that or those elements for further action using an input device, such as, for example, via typical mouse events. For example and without limitation, right clicking may invoke a menu of action items which may be performed on an element (e.g., without limitation, in a patent context: link to full patent text at the USPTO; link to an image file at the USPTO; link to that image file and dynamically create a pdf file from the separate image pages; create a patent landscape map for the element; etc.) and/or left clicking may select and highlight the element or elements for further action. The actions which may also be performed on the magnified or highlighted element may be made context sensitive based at least in part on the type of element and/or attributes of or relating to the element. For example, without limitation, in a patent map context, it may be desirable that “issue date” or “assignee”, if selected, triggers specific menus.

It is desirable to be able to use a variety of methods to select one or more graphical elements for analysis and/or review. For example, a user may want to select an element from a list of elements which are contained in a dataset. This task may be facilitated if a user is able to set the selection criteria(on) in one area or window, such as a selection window, and have the results displayed in another area or window, such as a target window. In one such embodiment, a selection window may display a list of elements within a target window and a user may select one or more of the elements using one or more criteria. Likewise, the elements so selected may be shown as selected in the target window. The elements may be displayed in the selection window in any manner of groupings—e.g., by date, name, word phrases, and/or other classification methods. The elements so selected may be shown in the target window in a variety of ways as well, such as, but not limited to: changed characteristics (e.g., highlighting, coloring, shading), changed size and/or shape, and/or through motion of a graphic (e.g. blinking, rotating).

The foregoing describes selections from a description or listing of elements of a dataset from which a selection is to be made. Additionally, a user may want to know if element(s) from one or more datasets, such as datasets produced in response to a query, for example, are included in one or more datasets. Here, such datasets may be referred to as query selection datasets without loss of generality. In these cases, a selection window might, for example, display a description or listing of the elements in a query selection dataset in any manner of groupings and/or classification methods such as these previously described, for example. In this embodiment, selecting the elements in a selection window may result in those elements being shown in a target window if those elements were contained in the queried dataset. A target window may show the queried dataset(s) in a variety of forms, such as, for example, tabular (list), charts (histogram, pie chart, bar chart) and/or graphic (maps or other spatially oriented displays), and may display the location of selected elements spatially within the form of display. A query selection dataset may also contain a single or small number of elements and may be entered manually, such as by a user, as in, without limitation, typing a patent number. More than one selection window may be used and/or more than one target window may be used, depending, for example, at least in part on the particular embodiment.

A selection window may contain a variety of features which may further facilitate selection of elements, such as: list sorting by criteria (ascending or descending numbers and/or letters), filtering by criteria, analyses (e.g., histogram categorization as in, for example, without limitation, patent assignee, issue and/or filing date, inventor(s), US patent class and/or subclass, dtc.), dataset combination techniques (e.g., intersection of dataset A and dataset B or union of dataset A and B, etc.).

For example, in one situation, by way of illustration, a target window may contain a landscape citation map of a patent portfolio of company 1. In a selection window, a list which comprises the patent portfolio of company 2 may be provided. The patent portfolio for company 2 may be combined with the portfolio for another company, such as company 3 for example. A US Patent Class and/or sub-class categorization may be applied for one or more classes and/or subclasses of interest to the combined portfolio of companies 2 and 3. A target window may show where the patents of the combined portfolio are situated with respect to the patent portfolio of company 1. Of course, this is merely one example of an application of selection embodiments described above and claimed subject matter is not limited in scope to this particular example.

It may also be useful to be able to display elements in different formats and to be able to select elements in one format and display them in another format. For example, it may be desirable to transform from a list or tabular display to a graphical display, such as a map. One might display a portfolio of patents in a tabular or list format, for example. One might perform operations on the list, such as a sort by inventor, for example. One might select the patents of a certain inventor in the sorted list and view how those patents appear on a citation map of the patents in the portfolio. Likewise, it may be desirable to transform from a graphic to a list format. One might display a portfolio of patents in a citation map format, for example. On the map, one might see a cluster of patents, “select” that cluster, produce a tabular list of the patents in the portfolio, and view where the selected patents appear in the list, for example. To accomplish this, in this embodiment, selection criteria are synchronized between list and graphic formats such that a selection in one format makes a corresponding selection in another format.

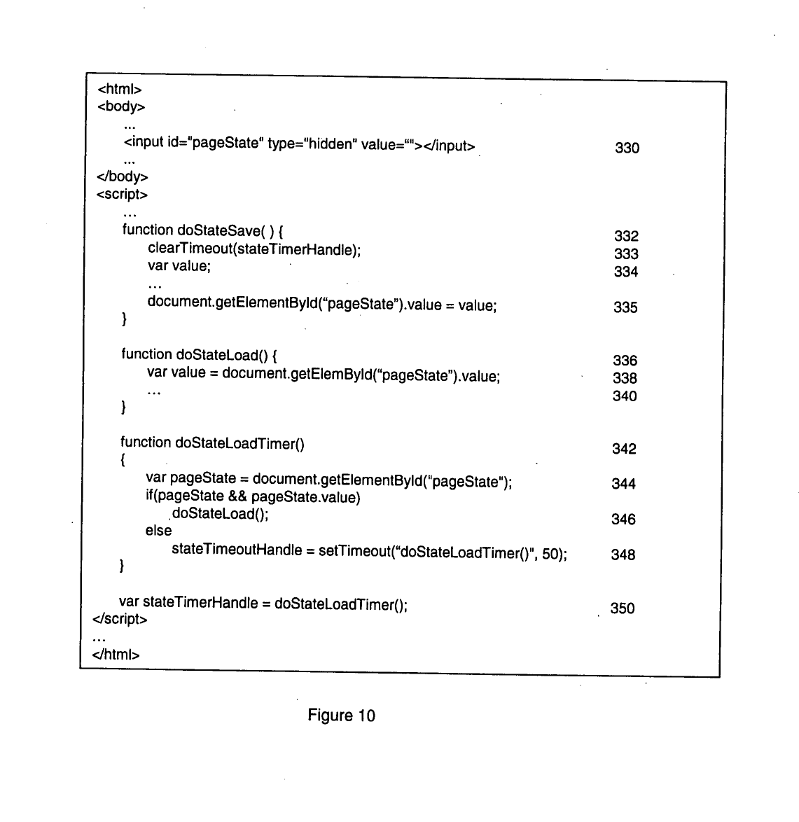

In another embodiment in accordance with claimed subject matter, a HTML page may obtain data from a server, such as a web server, on demand, in response to user interaction. In this approach, a browser, such as a web browser, may initially receive a portion of the data from the server. To shorten the time for the page to load, in this embodiment, this portion may be displayed and additional data may be obtained from the server later without reloading the page. As one example, without limitation, a file explorer page may present a tree view of a document file system and allow a user to open and/or close the file folders to reveal or hide the subfolder and/or files. FIG. 12, for example, is a schematic diagram showing a file system rendered in a tree view in which a node represents a file or a folder. Initially, the browser receives data for the root node and immediate sub-nodes, such as nodes 12, 13, 14, and 15 in FIG. 12. Thus, the browser renders the first level of the file system hierarchy. If the user selects a folder node, such as via a mouse click, for example, and its sub-node data has not been received, an additional payload of data may be requested from the server to render the sub-nodes, for this particular embodiment.

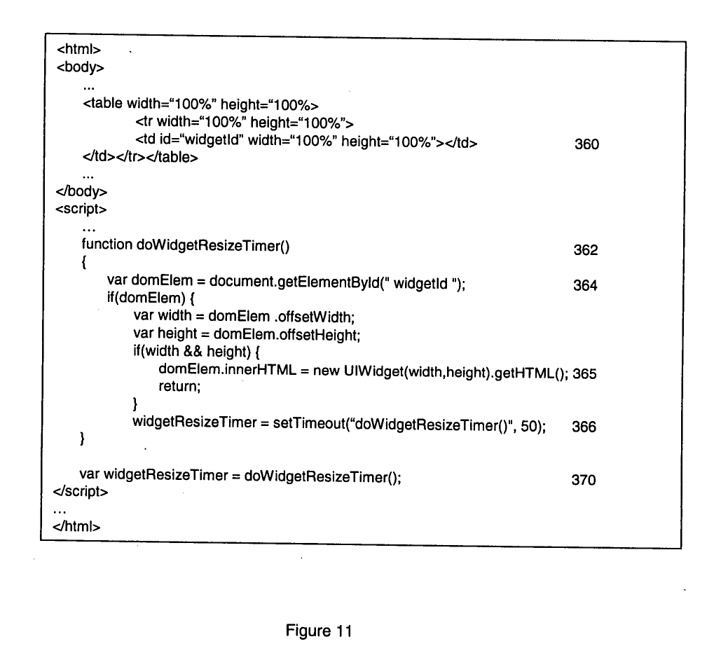

An embodiment of a just-in-time data mechanism may therefore be implemented in Javascript code executing in a browser. In this example, file explorer functionality may be embodied in UITreeNode Javascript objects. Referring to FIG. 13, at 750, a user may open a folder node via the file explorer, resulting in a corresponding UITreeNode object at 751 determining if it already has data for its sub-nodes. If so, the UITreeNode object may render its sub-nodes at 756 using the sub-node data.

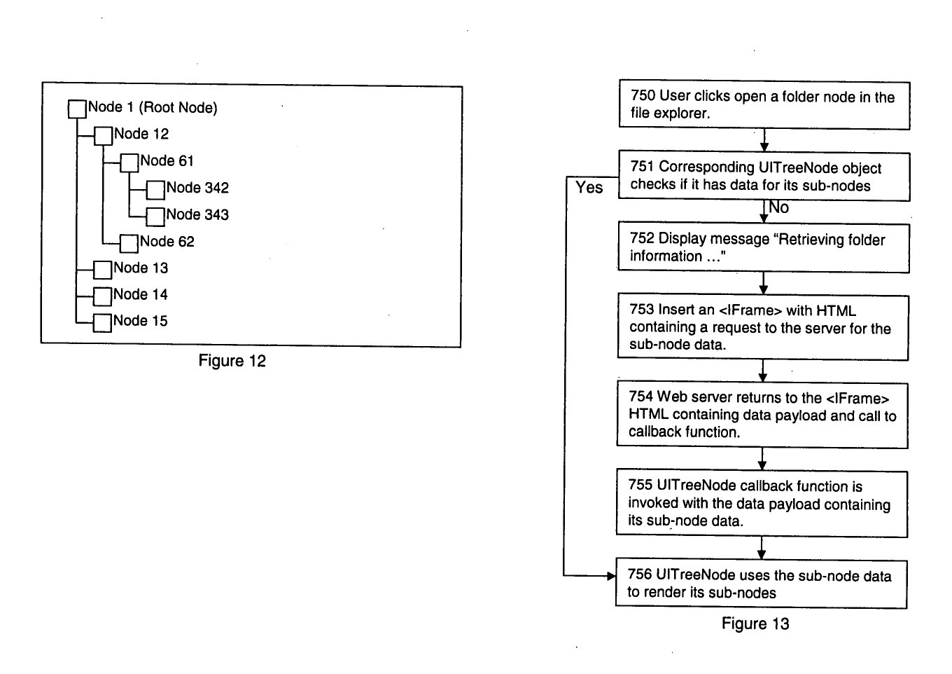

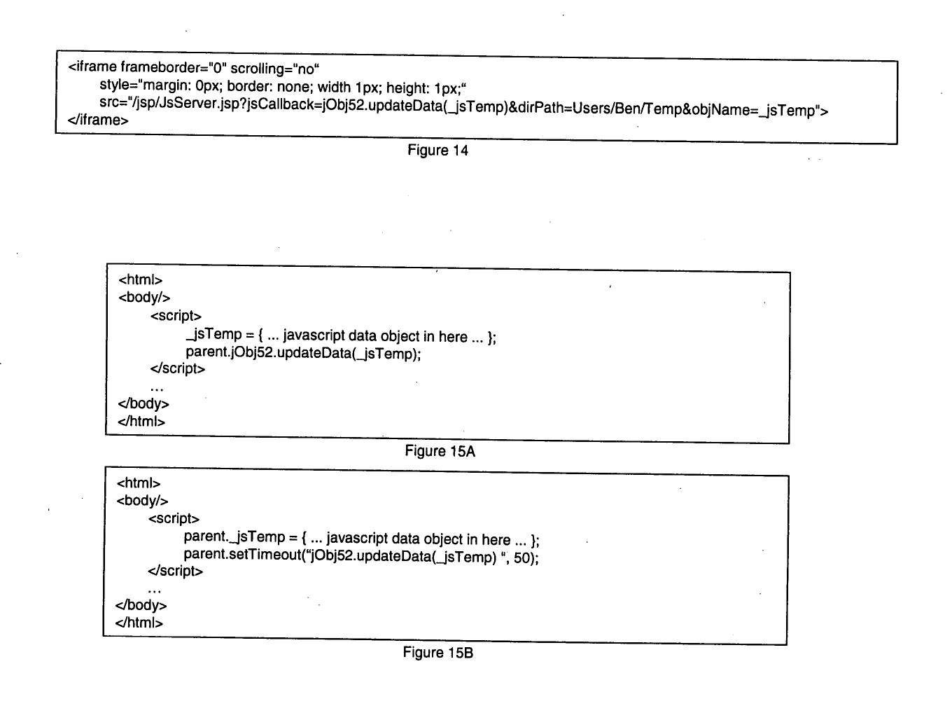

If the UITreeNode object does not have data for its sub-nodes, it may display a message, such as “Retrieving folder information . . . ” at 752, in this particular embodiment, for example. The UITreeNode object at 753 may insert an <IFrame> with HTML including a request to the server for the sub-node data. For example, the <IFrame> may be in the original HTML page, or it may be added dynamically using a DOM interface. The <IFrame> may be sized, positioned and/or layered so it is not visible on the page. In FIG. 14, HTML in the <IFrame> may specify the requested data (as a directory path), the name of the data object to return, and/or a callback function to call after the data is returned. So that the call back goes to the desired object, UITreeNode objects have assigned unique pointers in this particular embodiment. The server may fill the request and, at 754, may return to the <IFrame> HTML including a data payload and/or a call to the callback function. An example of HTML returned in the <IFrame> is given in FIG. 15A. The callback function may be invoked at 755 with the data payload containing its sub-node data. At 756, the UITreeNode object may render its sub-nodes using the sub-node data. Of course, this is simply one embodiment and claimed subject matter is not limited in scope to these particular details.

For example, variations of the approach described may be advantageous for use with certain browsers. For instance, in one particular embodiment, delaying the execution of the callback function by 50 milliseconds, illustrated in FIG. 15B, may be more robust with some browsers. Another variation, for recent browsers that support it, may be to use an XML HTTP Request, instead of an <IFrame>, to make a just-in-time data request to the server. In this case, the XML HTTP Request may be supplied with the callback function to receive the data directly.

In addition to the file explorer example, described above, a just-in-time data mechanism may be applicable if a page uses relatively large amounts of data on demand from the server. For example, a graphic, such as a map, in which a sub-portion of the map is shown, may have additional sections of the map downloaded as the map is moved or scrolled to expose a different section.

A variation may also be to obtain the data for a page around the time the page is loaded, and employ just-in-time construction of the HTML. One example includes a web page that displays data on two or more tabs, where one tab is shown. If a tab is shown for the first time, its HTML is constructed from the data using JavaScript code. This saves the time of constructing HTML for tabs that are not yet shown. Another example is to display a large table, such as wiht thousands of rows, as an example, in sections of 50 rows, for example. Initially the HTML to show the first 50 rows is constructed. Is a request to see more rows is made, the HTML for the additional rows is constructed. Furthermore, with the data already in browser, sorting functions may be implemented in JavaScript to sort the data by various criteria. In this way, rapid resorting of large tables may be achieved without going back to the server, and sections of the resorted table are rendered on the page using just-in-time HTML.

A browser may cache relatively large amounts of Javascript (JS) data and/or code, but still allow the server to effectively expire outdated JS data and/or code, resulting in the browser requesting updated JS data and/or code from the server. This approach is useful in situations in which an update is unpredictable or difficult to predict, so that a fixed expiration or timeout may not be satisfactory or appropriate.

A composite JS file may include Javascript data objects, Javascript code (e.g., classes, methods, functions, etc.) or combinations. A composite JS file may be created by aggregating JS code from other JS files or from other sources, such as database records. Contents of a composite JS file may be customized to a particular browser session, user or class of users, and/or set of permissions assigned to a user. Composite JS files may be used by pages that employ JavaServer Page (JSP) or other dynamic web page technology. A composite JS file may also be created by a server on demand.

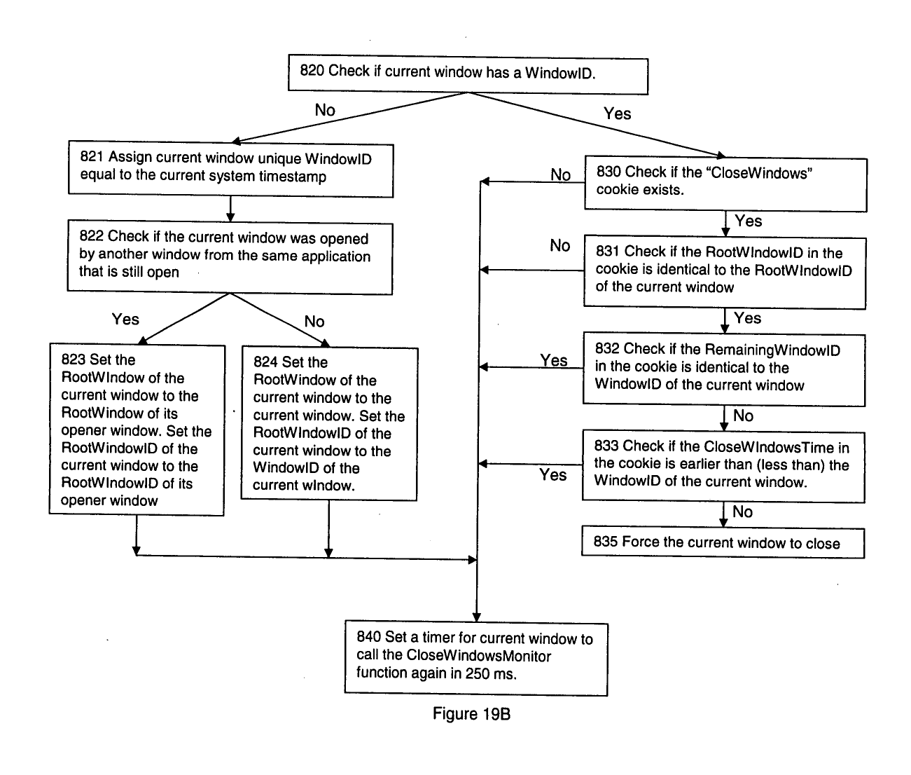

For this particular embodiment, a composite JS file may be created and managed by a server-side software module called the JS Web Include Manager Referring to FIG. 20A, a composite JS file may be registered at 500 with the JS Web Include Manager by specifying a Reference ID and a list of component JS files to aggregate. Registration may take place at the time a server starts up, or it may take place dynamically. Referring to FIG. 20B, if an HTML page writer (JSP) is to include a composite JS file, it executes a function call at 501 to the Web Include Manager to get an HTML <script> directive to include the JS file corresponding to a particular ReferenceID. The Web Include Manager checks if an up-to-date composite JS file exists that corresponds to the ReferenceID. The Web Include Manager may keep a cache of the contents of composite JS files indexed by ReferenceID, depending at least in part on the particular embodiment, for example. If the composite JS file does not exist or is out of date, at 504, the Web Include Manager may create a composite JS file from one or more component JS files specified at the time of registration, for example. The Web Include Manager may at 506 save the composite JS file with a globally unique file name, and may associate the Reference ID with a globally unique URI that will return the composite JS file if presented to the server. At 508, the Web Include Manager may return an HTML <script> directive, shown in FIG. 20C, that may contain a URI for the up-to-date composite JS file. At 510, the HTML page writer may put the <script> directive into the HTML page. As interpreted by the browser, at the appropriate time, the <script> directive may result in download of the composite JS file from the server by the browser. The uniqueness of the URI assigned to the composite JS file in this particular embodiment may therefore facilitate the composite JS file downloaded by the browser being up-to-date.

A given HTML page may include one or more composite JS files, with a composite JS file containing a distinct type of information. For instance, it may be advantageous to create separate composite JS files for session-specific, user-specific, and/or universal information. Similarly, it may be advantageous to create separate composite JS files for relatively static information and information that may change.

The contents of a composite JS file may be modulated by session-specific information, such as, for example, user, class of user, and/or permissions assigned to the user. For instance, certain types of data or functionality may be included or omitted from a composite JS file based at least in part on such information.

In a web-based application, it may be desirable to marshal substantial amounts of data back and forth between a server and a browser, such as a web server and a web browser, for example. Various components of an application, for example, may handle data in different forms. This particular implementation or embodiment, for example, may make use of hierarchical data objects to store and/or convey data, although claimed subject matter is not limited in scope in this respect. Nonetheless, here, a server may handle data in the form of Java objects, while a browser may handle data in the form of Javascript (JS) objects. Persistent data objects may be stored in XML files or databases. Transformation of data objects between Java, XML and/or JS forms may therefore enable the various separate components to handle the same or substantially the same data.

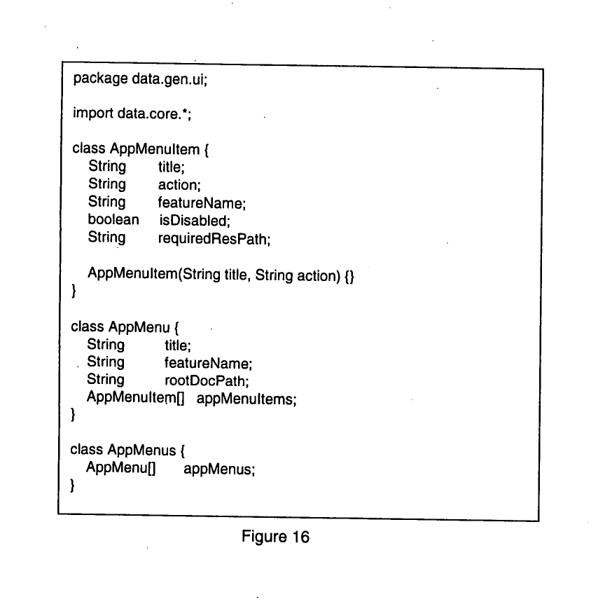

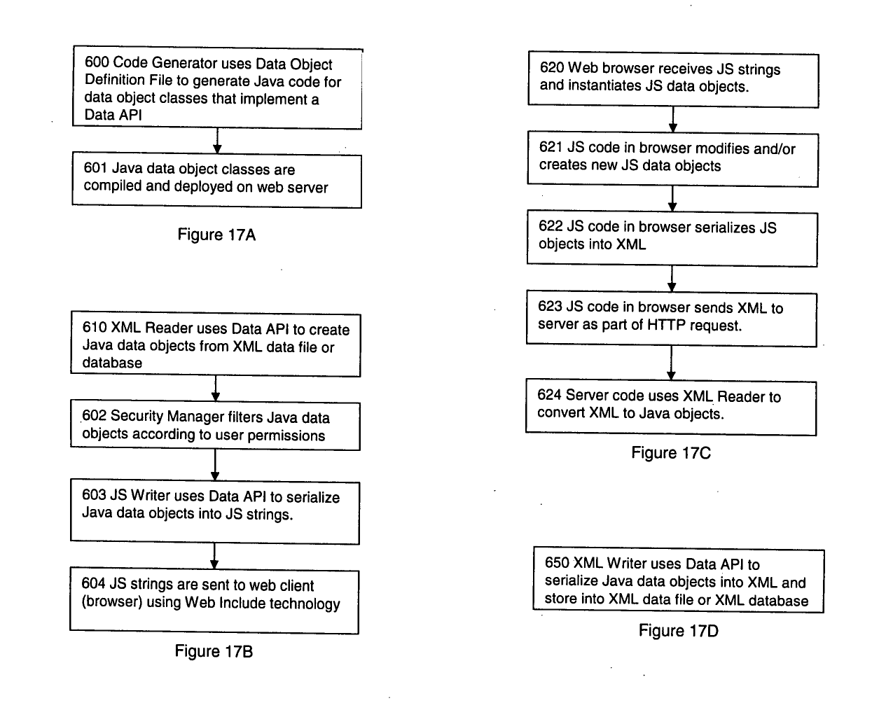

A hierarchical structure of the data objects may be defined in one or more Data Object Definition Files, as illustrated, for example, in FIG. 16. In FIG. 17A, at 600, a Code Generator program may use a Data Object Definition File to generate Java data object classes that may implement a Data API for this particular embodiment. A data API may comprise an interface that facilitates serialization of data objects. In one embodiment, data API may enable getting and/or setting data values, as well as interrogation of a structural hierarchy of the data objects. At 601, the generated Java data object classes may be compiled and/or deployed on a web server. Data objects could be similarly generated in another object-oriented programming language, such as C++ or PHP, that executes on the web server, for example.

In this particular embodiment, the web server may include an XML Reader module to access persistent data stored in the form XML files, or as XML blobs in a database. In FIG. 17B, the XML Reader may use the Data API to create Java data objects from an XML data file. The Security Manager module may filter the Java data objects according to the user permissions at 602. The JS Writer module may use the Data API to serialize Java data objects into JS strings at 603. At 604, JS strings may be created that will generate JS objects if evaluated as JS statements in the browser. The JS strings may be sent to the browser using the Web Include technology previously described in connection with FIG. 20, in this particular embodiment. Alternatively, JS strings could be embedded directly into a HTML page such as, within a <script> element, for example.

In FIG. 17C, the browser may receive the JS strings and generate JS data objects that replicate the structure and content of original Java data objects. JS code executing in the browser may use JS data objects to build the visual presentation. As a result of user-interaction, JS code in the browser may modify and/or create JS data objects at 621. The JS code in the browser may serialize JS data objects into XML, at 622, and, at 623, may send the XML to the server as part of an HTTP request. If the server processes the request, it may use the XML Reader to convert the XML to Java objects at 624. The server may use a XML Writer module for persistent storage of Java objects in this embodiment. Referring to FIG. 20D, the XML Writer may use the Data API to serialize Java objects into XML and store it in a XML file or database at 650. As an alternative to a Data API and code generation of data object classes, as described above, a native reflection API of an object-oriented language, such as, for example, Java, C++, or PHP, could be used to extract the structural hierarchy of the data object classes.

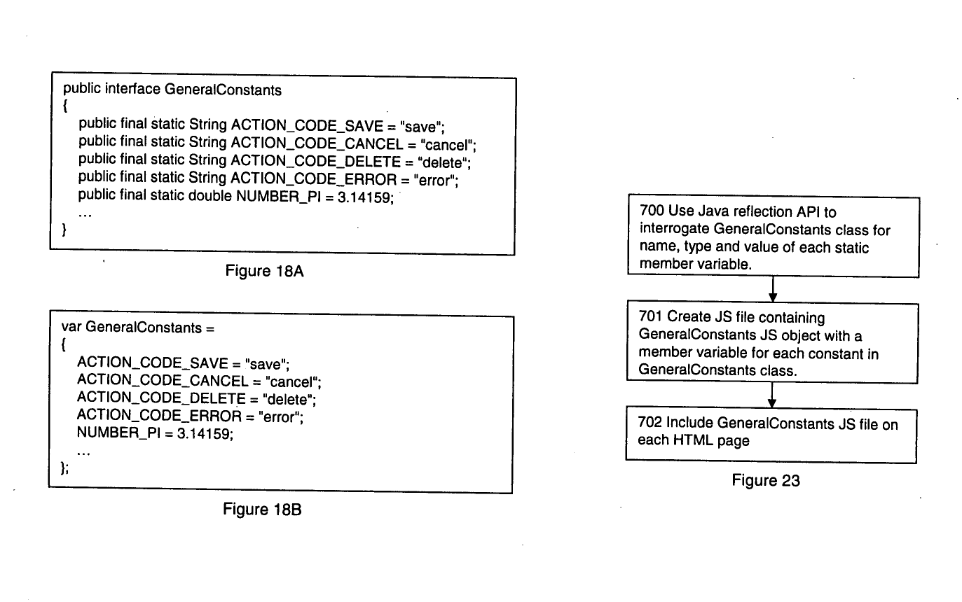

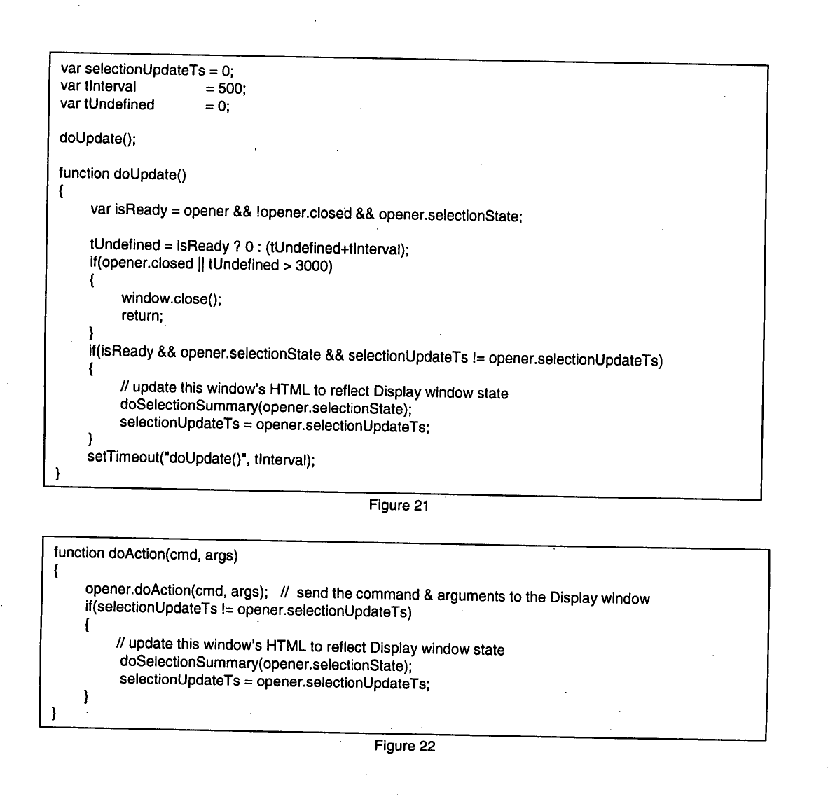

In a web application that uses web pages including Javascript (JS), it may be useful to provide JS code executing in the browser with the same or substantially the same constant values used in the server code. Thus, for one embodiment, a set of constants defined in Java code on the server may be used to create a JS file with such values. For this particular embodiment, common constants used in the web application may be defined in a single Java class, GeneralConstants, as shown in FIG. 18A. The server at start up or at another time may use the Java reflection API to interrogate a GeneralConstants class for the name, type and/or value of static member variables. The server may create a JS file containing a GeneralConstants JS object with a member variable for constants in the GeneralConstants class at 701, as shown in FIG. 23. The names and/or values of the JS object, shown in FIG. 18B, for example, may correspond to those in the GeneralConstants Java class. The GeneralConstants JS file may be included on an HTML page at 702. The Web Include technology previously described in connection with FIG. 20 may also be used to include the GeneralConstants JS object on an HTML page.

Web applications may at times open multiple browser windows within the same browser session, providing functionality to the user. If the user logs out of the application from one of the windows, however, the other windows may continue to show content from the web application, but are not actionable if the server has logged the user out. It may be desirable, therefore, to close multiple windows if a user logs out so that misleading, out of date, data is not presented to the user inadvertently.

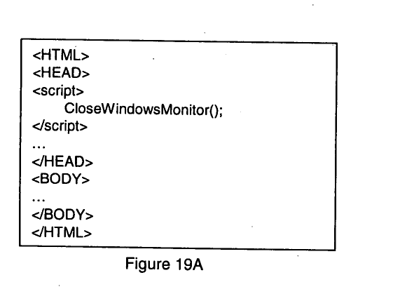

In one embodiment, an HTML page served by an application server may contain a section of JS code with a call to a CloseWindowsMonitor function, as illustrated in FIG. 19A. A CloseWindowsMonitor function may be defined in a JS file that is included in an HTML page for example. The CloseWindowsMonitor function may implement a process, as illustrated in FIGS. 19B and 19C. At 820, whether a current window has a WindowID parameter is checked. If not, the current window is assigned a unique WindowID corresponding to the current system timestamp at 821. Whether the current window was opened by another window from the same application that is still open is checked at 822. If so, at 823, the RootWindow parameter of the current window is correspondingly set, and the RootWindowID parameter of the current window is correspondingly set. Otherwise, the current window may be designated to be the root by being correspondingly set

For the case in which a current window already has a WindowID, this process embodiment may check if a “CloseWindows” cookie exists at 830. If the cookie exists, at 831, a RootWindowID in the cookie may be checked to see if it corresponds to the RootWindowID of the current window. If so, at 831 the RemainingWindowID in the cookie may be checked to determine if it corresponds to the WindowID of the current window. If not, such as if the current window was not designated as the remaining window, the CloseWindowsTime may be checked in the cookie to determine if it is earlier than the WindowID of the current window. If it is not earlier, the current window may have existed prior to the “CloseWindows” cookie, and the current window is closed at 835 in this particular embodiment. In all other cases, a current window is allowed to remain open, and a timer is set at 840 for the current window to call a CloseWindowsMonitor function again in 250 ms for this embodiment. The timer call allows a window to periodically check the “CloseWindowsCookie,” if it exists, to determine whether it is time to close.

If the user of the web application logs out, the CloseWindows function is called. Referring to FIG. 19C, the CloseWindows function identifies a single window at 850 to remain open after the logout operation occurs, referred to here as the Remaining Window. The RemainingWindowID parameter may be correspondingly set at 851 resulting in the Remaining Window executing a logout operation at 853. The CloseWindows function may set a CloseWindowsTime parameter at 854 corresponding to a current system timestamp. It may at 855 create or update a “CloseWindows” cookie with the following parameters: RootWindowID, RemainingWindowID, and/or CloseWindowsTime, in this particular embodiment. According to the process embodiment described above, a browser window associated with the application may check this cookie, and may close itself if it (a) is descended from same root window, (b) was created prior to the cookie and/or (c) has not been designated as the remaining window. Of course, this is merely one possible embodiment and claimed subject matter is not limited in scope to this particular embodiment.

If displaying data in a browser window, separate auxiliary windows may be used for facilitating selection. For instance, items may be shown in the form of a graphic or list in a display window, and/or one or more selector windows may be opened for the purpose of marking, grouping and/or otherwise manipulating items in the display window. It is desirable to synchronize display and selector window contents to facilitate such operations, although claimed subject matter is not limited in scope in this respect

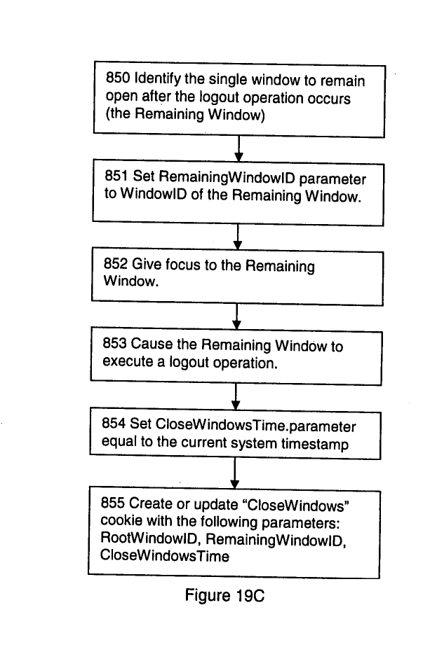

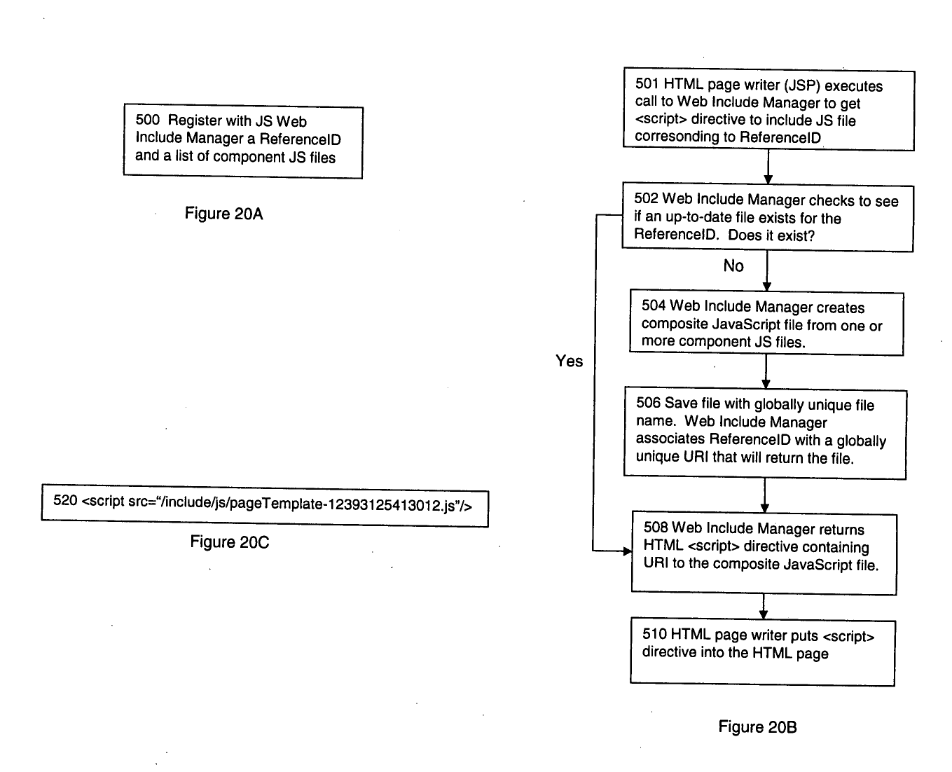

The windows to be synchronized may be “sibling” windows opened by a common opener window, or may itself be the common opener window in this embodiment. Typically, the display window is the opener of one or more selector windows. Communication between the windows may be performed by Javascript (JS) code in selector windows that use the opener variable to access state variables and functions in the display window. In addition, a selector window may use the opener variable to close itself if the display window closes. Sample JS code in FIG. 21 shows how a selector window may periodically run a doUpdate function, such as every 500 ms, in this particular embodiment. The doUpdate function may allow changes in the state of the display window to be reflected in the selector window. The use of timestamps may allow the selector window to update its HTML if it is out of date with the display window. The doUpdate function also may result in the selector window closing if the opener window is closed or not available for 3 seconds, for example, in this particular embodiment. FIG. 22 shows an example of a doAction function for a selector window which is called in response to a user-interface command, although claimed subject matter is not limited in scope in this respect. In this example, a command may be passed directly to a doAction function of a display window, and a selector window updates its HTML if it is out of date. An alternative approach is for the doAction function of the selector winder to handle the command itself by directly modifying the selection state of the display winder via the opener variable, although, again claimed subject matter is not so limited.

In an alternate embodiment, for a Java-enabled browser, an entity graphic creation may employ such functionality in a variety of ways, although claimed subject matter is not limited in scope in this respect. Creation of bitmaps, for example, may be delegated to an applet executing in the browser, for example. The applet may employ permissions to serve on a port. Images for the graphic background or images for the entity item shapes may be created by the applet, for example, instead of by the server, in one possible embodiment. This may not only offload work from the server, but may provide the images to the browser more quickly, allowing the graphic to render faster. The applet may receive the information needed to create the graphic through various possible mechanisms. For example, the basic information to define the bitmaps may be streamed from the server or transferred to the applet through the Javascript-Java browser interface.

It will, of course, be understood that, although particular embodiments have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and configurations were set forth to provide a thorough understanding of the claimed subject matter. However, it should be apparent to one skilled in the art having the benefit of this disclosure that claimed subject matter may be practiced without the specific details. In other instances, well-known features were omitted or simplified so as not to obscure claimed subject matter. While certain features have been illustrated and described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. An apparatus comprising:
means for creating a graphical application interface via a browser without a browser plug-in; and
means for browsing.

2. The apparatus of claim 1, wherein said browser comprises a web-browser.

3. The apparatus of claim 2, wherein said means for creating a graphical application interface comprises means for creating an HTML-based graphical application.

4. The apparatus of claim 1, wherein said means for creating a graphical application interface includes:
means for hiding portions of a region larger than a viewable area.

5. The apparatus of claim 4, wherein said viewable area over said region is capable of changing.

6. The apparatus of claim 5 wherein said viewable area is capable of changing via at least one of the following: grabbing said region substantially in accordance with motion of an input device; using an overview tool that represents said region; or click and drag selection.

7. The apparatus of claim 1, wherein said creating a graphical application interface includes:
means for saving and reloading a prior dynamically created page.

8. The apparatus of claim 1, wherein said means for creating a graphical application interface includes:
means for autosizing an image to fit an available viewable area.

9. The apparatus of claim 1, wherein said means for creating a graphical application interface includes:
means for dynamically creating a magnified view of a portion of a visual display.

10. The apparatus of claim 9, wherein said means for dynamically creating a magnified view comprises at least one of: means for creating a flyover window or means for creating a hover window.

11. The apparatus of claim 1, wherein said means for creating a graphical application interface includes:
means for selecting from a sibling window.

12. The apparatus of claim 11, wherein said means for selecting from a sibling window includes means for selecting at least one of the following: highlighting; coloring; shading; blinking; changing size; changing shape and/or rotating.

13. The apparatus of claim 1, wherein said means for creating a graphical application interface includes:
means for switching between presentation formats.

14. The apparatus of claim 13, wherein said means for switching includes means for switching between at least a tabular and a graphic format.

15. The apparatus of claim 1, wherein said means for creating a graphical application interface includes:
means for displaying additional data without reloading a page.

16. The apparatus of claim 1, wherein said means for creating a graphical application interface includes:
means for dynamic updating data and/or code.

17. The apparatus of claim 1, wherein said means for creating a graphical application interface includes:
means for marshalling data between a web server and a web browser.

18. The apparatus of claim 1, wherein said means for creating a graphical application interface includes:
means for closing a family of windows.

19. The apparatus of claim 1, wherein said means for creating a graphical application interface includes:
means for synchronizing display windows and selector windows.
